(19) United States
(12) Patent Application Publication
(10) Pub. No.: US 2005/0225789 A1
(43) Pub. Date: Oct. 13, 2005

(54) Print subsystem despooling backplane

(75) Inventor: Andrew Rodney Ferlitsch, Tigard, OR (US)

Correspondence Address: Gerald W. Mallszewski, P.O. Box 270829, San Diego, CA, 92198-2829, US

(73) Assignee: Sharp Laboratories of America, Inc.

(21) Appl. No.: 10/731,400

(22) Filed: Dec. 9, 2003

(51) Int. Cl. G06F 15/00

(52) U.S. Cl. 358/1.13

(57) ABSTRACT

Provided are a print subsystem despooling backplane and a method for managing print jobs using a print subsystem despooling backplane. The method comprises: accepting a print job at a print subsystem despooling backplane input interface; calling a despooling backplane plugin; converting the print job into an internal representation (IR) document that is typically independent of a printer device target and the language format associated with a printer device target; processing the IR document in response to a plugin; converting the processed IR document into a processed print job; and, supplying the processed print job at a despooling backplane output interface. The called plugins can be user-selected plugins, predetermined plugins that are responsive to criterion such as printer driver, printer model, printer configuration, printer condition, user, administrative grouping, or document type, and plugins called from other (previously called or currently running) plugins.

### BACKGROUND OF THE INVENTION

1. Field of the Invention

This invention generally relates to digital printer processes and, more particularly to a printer subsystem despooling backplane for managing print jobs.

2. Description of the Related Art

FIG. 1a is a depiction of a print subsystem print processor (prior art). Such a print processor can be used, for example, to customize despooling processes in the Microsoft Windows® family of operating systems. In this method, the custom print processor is compatible with the print spooler input and control interfaces, as well with the port manager output and control interfaces. The custom print processor may be used to perform some action in addition to, or in place of the system (default) print processor. A pool printing example action reroutes a print job to a compatible printer, if the targeted printing is not available. Sharp EZ Cluster® is an example of a product that supports printer pooling by using a custom print processor.

This method suffers in that the custom action is hardcoded (compiled as object code) in the custom print processor. Therefore, it can only perform a (single) preprogrammed process. Neither can the method combine multiple custom despooling processes. Only a single custom print processor can be specified. That is, the processors cannot be chained.

FIG. 1b is a depiction of a print subsystem custom port manager (prior art). Such a port manager can be used to customize despooling process, such as in the Microsoft Windows® family of operating systems for example. In this method, the custom port manager is compatible with the print processor input and control interfaces. The custom port manager performs some action in addition to, or in place of the actions that are typically associated with a port manager. An example of such an action is the splitting of multiple copies of the same job to one or more printing devices, in addition to the targeted printing device. Ricoh Smart Net Monitor® is an example of a product that supports copy splitting using a custom port monitor, which is a component of a port manager.

The method suffers in that the custom action is hardcoded (compiled as object code) in the port manager and can, therefore, only perform the preprogrammed single process. Neither can the method combine multiple custom despooling processes. Only one custom port manager can be specified (no chaining).

FIG. 1c is a depiction of a print subsystem print assist process (prior art). Such a print assist can be used to customize the despooling process. The print assist can be any process that is added to the print subsystem between the printer driver and port manager. The print assist is able to intercept the print data stream between these two components. For example, the print assist may intercept the data stream by linking to the calling output interface and input interface of the print processor and port manager. The print assist then performs some additional action on the print data stream. An example of an action is the modification of the print stream, to specify some additional print option that was not specified, or supported at the time the print job was generated by the printer driver.

U.S. Pat. No. 5,995,723, entitled CLIENT SUBSYSTEM FOR CHANGING DOCUMENT/JOB ATTRIBUTES IN A NETWORK PRINTING SYSTEM, discloses such a system. This method suffers in that the custom action is hardcoded into the print assist and can, therefore, only perform the preprogrammed single process. Even if it were possible to chain print assist programs together, the operations may be order dependent. For example, a first print assist may modify a print job, with encryption for example, so that a second print assist is unable to parse it. Even if multiple print assists were chained, they would repeat common processes, such as parsing the print data, without the benefit of sharing the common process.

FIG. 1d is a depiction of a print subsystem using chained print processors (prior art). Such a method might chain two custom print processors using a client and server print subsystem. In this method, a print job is generated on a client and passed through a custom print processor. The print job is then despooled from the port manager on the client to a print server, such as in a network printer in the Microsoft Windows® family of operating systems. On the print server, the spooled print job from the client is despooled through a second custom print processor. The client and server custom print processors then perform some action in addition to, or in replacement of the system (default) print processor. For example, a client-side custom print processor may implement copy splitting to multiple network printers, where each network printer has a custom print processor. To continue the example, the server-side custom print processors may perform an additional task, such as job accounting. Sharp EZ Cluster® and Equitrac PAS®, when used together, would be an example of a system that combines a client-side custom print processor (EZ Cluster®) with a server-side custom print processor (PAS®).

This method still suffers in that the custom action is hardcoded into the client and server-side custom print processor and can, therefore, only perform the preprogrammed single process. Only two custom actions can be combined. Further, the operations may be order dependent. The dual custom print processors are likely to be inefficient, in that they might repeat common processes, such as parsing the print data. The system is limited to network printers, and does not support local or remote printers.

FIG. 1e illustrates a print subsystem including a print assist (prior art). EU patent EP1100002 A2, entitled A PRINTER DRIVER FILTER AND METHOD OF PRINTING THE SAME, discloses a system consisting of a print assist and a collection of print filters. The print assist intercepts a print job after it has been generated by a printer driver. Each print filter is a programmable script that implements a means to modify the print job, for support of a print operation that would otherwise not be supported by the printer driver. When the print job is intercepted by the print assist, the print assist displays a user interface (UI) for selecting one or more print filters. After the user makes a selection, the print assist executes each of the selected print filters on the print job.

While this method allows an unlimited number of custom actions, it still suffers in that the actions are limited to the modification of the print job itself. For example, the filters cannot support other operations such as job accounting, job splitting and printer pooling. Also, the print filters can only support the modification of print jobs whose language syntax is pre-known. The application of multiple filters is inefficient, in that they may all repeat a common process, such as parsing the print job. The application of multiple filters is order dependent, one filter applying an encryption process would interfere with the ability of a subsequent filters to parse the modified print job.

It would be advantageous if an adaptive means of customizing a print job could be developed that was not dependent upon hardcoded programs.

It would be advantageous if the application of multiple independent customization processes were order independent, and independent of the language format of the print job.

It would be advantageous if the above-mentioned multiple independent customizations be performed in response to a single parsing.

It would be advantageous if the above-mentioned adaptive customizing means could be used to support operations more indirectly related to print job management such as accounting, security, and job splitting, to name but a few examples.

### SUMMARY OF THE INVENTION

The present invention solves the above-mentioned problems by dynamically configuring custom despooling processes, such as job modification, job accounting, job control, and error recovery, without being limited to a single customization, or subject to the conflicts associated with multiple customizations. The present invention dynamically configures, prior or during run-time, multiple custom despooling processes into an existing print subsystem, using a despooling backplane. This method permits custom modifications to be performed at all stages of the despooling process, without reconstruction or reinstallation of an installed imager (printer).

Accordingly, a method is provided for managing print jobs using a print subsystem despooling backplane. The method comprises: accepting a print job at a print subsystem despooling backplane input interface; calling a despooling backplane plugin; converting the print job into an internal representation (IR) document that is typically independent of a printer device target and the language format associated with a printer device target; processing the IR document in response to a plugin; converting the processed IR document into a processed print job; and, supplying the processed print job at a despooling backplane output interface.

The called plugins can be user-selected plugins, predetermined plugins that are responsive to criterion such as printer driver, printer model, printer configuration, printer condition, user, administrative grouping, document content, or document type, or plugins called from other (previously called or currently running) plugins.

Examples of IR document processes include translating (parsing) the print job into an IR document, analyzing, modifying the print job data, modifying control of the print job, gathering print subsystem-external information related to the print job, setting print subsystem-external information related to the print job, and reassembling IR documents. In some aspects, reassembling IR documents includes removing conflicts between a plurality of processed IR documents. Converting the processed IR document into a processed print job includes converting the plurality of IR documents into the (single) processed print job.

Additional details of the above-described method and a print subsystem despooling backplane are presented below.

### BRIEF DESCRIPTION OF THE DRAWINGS

FIG. 1a is a depiction of a print subsystem print processor (prior art).

FIG. 1b is a depiction of a print subsystem custom port manager (prior art).

FIG. 1c is a depiction of a print subsystem print assist process (prior art).

FIG. 1d is a depiction of a print subsystem using chained print processors (prior art).

FIG. 1e illustrates a print subsystem including a print assist (prior art).

FIG. 2 is a schematic block diagram of the present invention print subsystem despooling backplane.

FIG. 3 is a diagram depicting a default system bypass.

FIGS. 4a and 4b are alternate depictions of the despooling backplane of FIG. 2.

FIGS. 5a and 5b are depictions of present invention exemplary print job parsing functions.

FIG. 6 is a diagram illustrating a device availability aspect of the present invention.

FIG. 7 is a flowchart illustrating the present invention method for managing print jobs using a print subsystem despooling backplane.

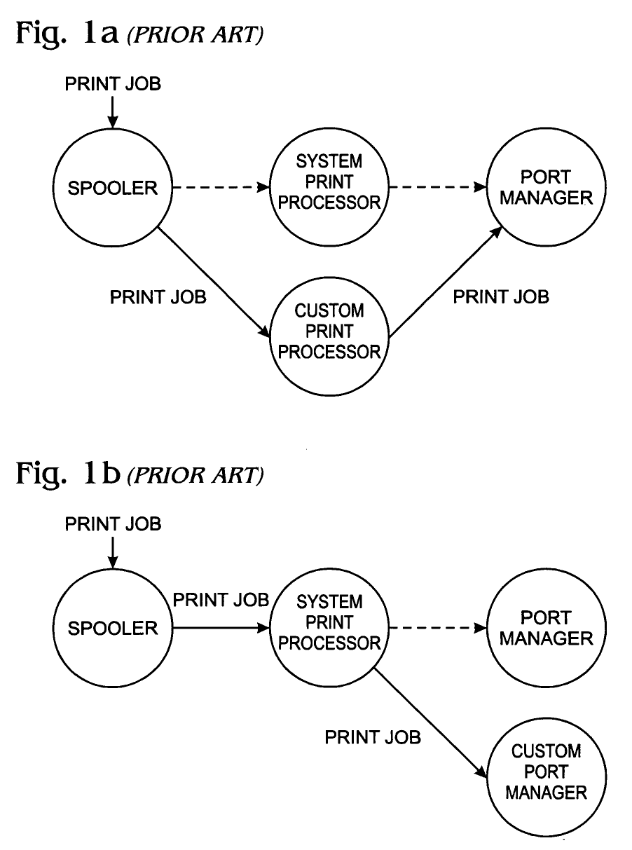

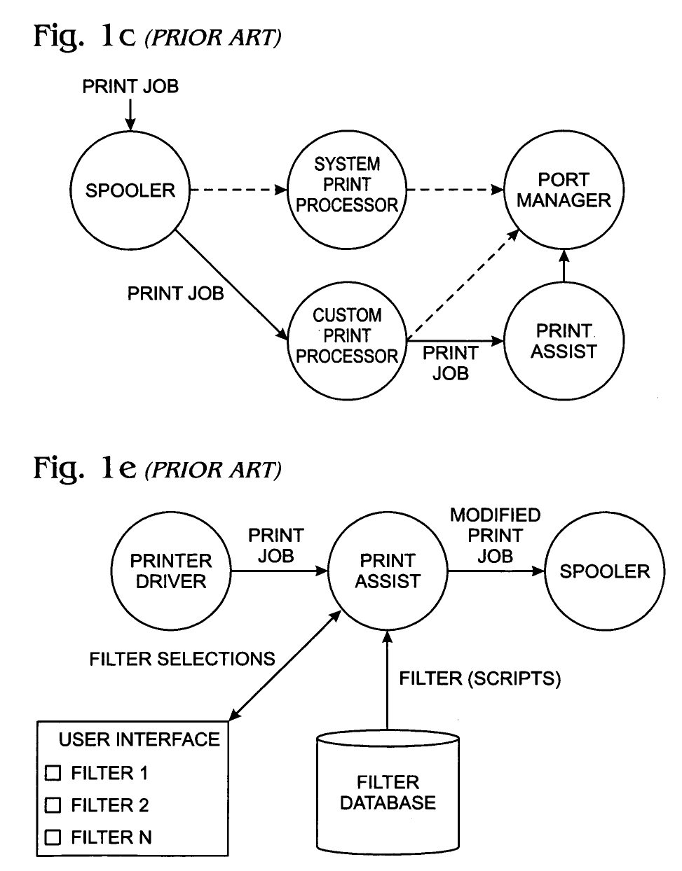

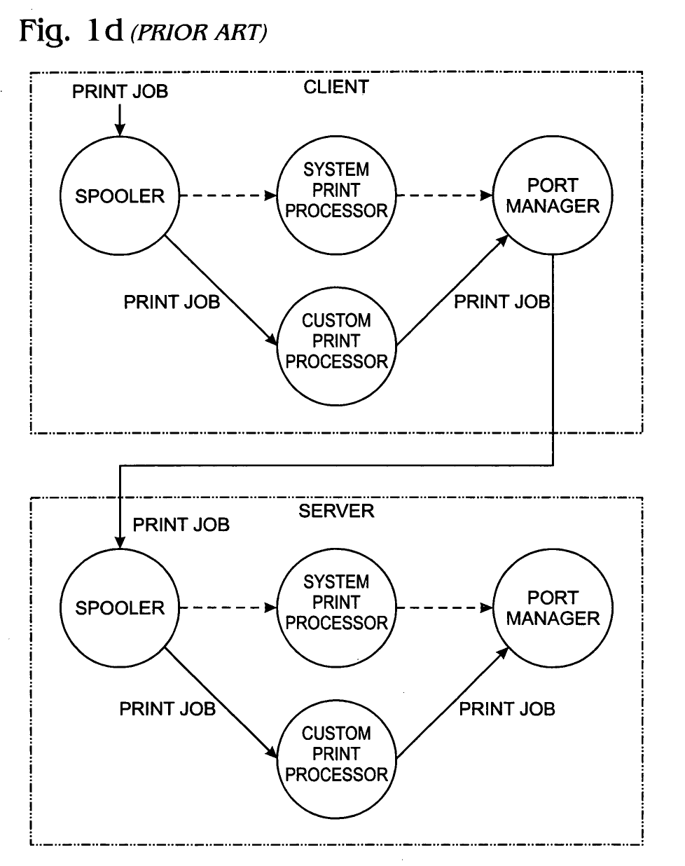

### DETAILED DESCRIPTION OF THE PREFERRED EMBODIMENTS

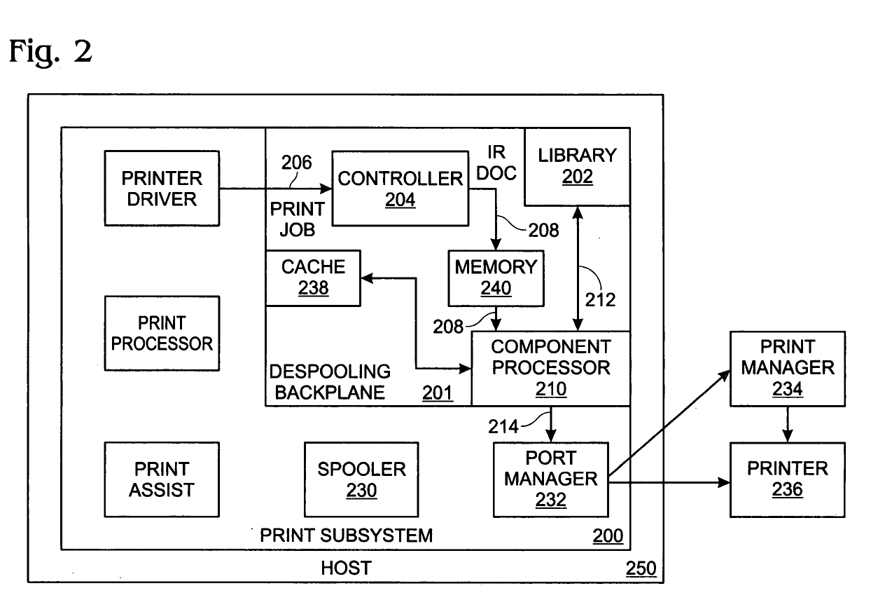

FIG. 2 is a schematic block diagram of the present invention print subsystem 200 despooling backplane 201. The backplane 201 comprises a library 202 of despooling backplane plugins and a controller 204. The controller 204 has an interface on line 206 to accept a print job. As shown, the print job is being supplied by a printer driver, such as in a print subsystem where the print driver prints directly (i.e., synchronously) to the port manager without spooling the print job. However, the print job can alternately be supplied by other elements in the print subsystem 200, such as a print spooler in the Microsoft Windows GDI print subsystem. A typical print subsystem may include all, or some of the following elements: a printer driver, a print processor, a print assist, a spooler, and a port manager. The controller 204 converts the print job to an internal representation (IR) document and supplies the IR document at an interface on line 208. Typically, the controller 204 converts the print job into an IR document that is independent of a printer device target and/or the language format associated with a printer device target.

A component processor 210 has an interface on line 212 to call a plugin from the library 202 and an interface on line 208 to accept the IR document. The component processor 210 processes the IR document in response to a plugin, converts the processed IR document into a processed print job, and supplies the processed print job at an interface on line 214. Line 214 is shown connected to a port manager, but in other aspects of the invention line 214 may be connected to other conventional print subsystem elements.

The component processor 210 may call user-selected plugins from the library 202. These plugins may be selected from a print driver user interface, or from a user interface provided by the component processor 210, for example. Alternately, the component processor 210 may call predetermined plugins responsive to criterion such as printer driver, printer model, printer configuration, printer condition, user, administrative grouping, document content, or document type. Many other types of criteria could also be used to help select a plugin. The criterion and associated plugins may be configured upon installation of the print subsystem, or set as a default condition, or programmed in response to the selection of a particular printer model, for example. In other aspects, the component processor 210 may call plugins that are called from other (previously called or concurrently running) plugins.

The component processor 210 may perform a number of processes. These processes may, or may not be directly related to the document. For example, document-related processes may include translating (parsing) the print job into an IR document, analyzing, modifying the print job data, and reassembling IR documents. Other processes more indirectly related to the document include gathering print subsystem-external information related to the print job, producing print subsystem-external information related to the print job, modifying control of the print job (such as spooling/despooling commands), and/or setting print subsystem-external information related to the print job.

The component processor translates the print job into an IR document by parsing spool/raster image processor (RIP) footers and headers, parsing a print job control header, and parsing language data such as page description language (PDL) data, image, or raster data. The component processor 210 parses a print job control header by calling a plurality of printer job control header plugins, such as printer job language (PJL) and job definition format (JDF) plugins. The print job control header plugin used, is the one that recognizes the print job control header data. Initially, the component processor 210 may call an industry standard printer job control header, such as a PJL plugin, for syntactical analysis and, then, a manufacturer or model specific version of the PJL plugin for semantic analysis.

The component processor 210 parses the language data by calling a plurality of language plugins, such as printer control language (PCL), portable document format (PDF), PostScript (PS), and PCL XL, HP GL/2, IPDS, Escape P, SCS, and TIFF plugins. In other aspects, the print data may be raster data or representations other than a PDL, such as images. In these aspects, the component processor 210 parses the print data by calling the appropriate print data format specific plugins. For example, the plugin used is the one that recognizes the data.

The component processor 210 analyzes the IR document by performing an action such as job accounting. Job accounting includes functions such as determining the number of physical sheets required to print the print job, toner usage, or other consumables such as staples in a stapling operation for example. Other analysis actions include printer pooling and job splitting. Printer pooling includes functions for routing a print job to one or more printers on the basis of availability, load balancing, performance, capability, locality, power consumption, and/or other resource usage. Job splitting includes functions such as copying, document splitting between different printers, and the separation of jobs by color (black-and-white (BW)/color separation). Analysis actions also include access control and security, where security involves encryption, auditing, steganography (e.g., using undefined bits in a file to hide a message), digital signatures, and types of encoding functions. Further, analysis may involve content filtering and resource downloading (e.g., form/font/overlay/watermark). Other examples of analysis are compression, reformatting (i.e., sheet assembly emulation, such as collation, booklet, reverse order, n-up), and language translation (converting from one print language to another language, or a variant of the initial print language).

The component processor 210 may gather print subsystem-external information related to the print job by monitoring a printer condition. Examples of monitored printer conditions include the availability of connected printing devices, currently printing print jobs, pending print jobs, completed print jobs, print job failures, printer performance, such as a pages per minute (ppm) specification, printer locality (how close the printer is to the user), printer capabilities such as stapling and duplex printing, and consumable availability such as toner and paper stock. Other, unnamed, printer conditions may also be monitored. The component processor 210 monitors printer condition by querying a node such as a print subsystem spooler 230, a print subsystem port manager 232, a printer device manager 234 (such as the network print spooler in a Microsoft Windows NT/2K/XP print server), a print service (not shown), such as the printer directory service in Microsoft Windows 2K/XP, or a printer 236. The selection of the node depends upon the design of the print subsystem 200, the printer design, and the network connecting the printer 236 to the print subsystem 200. In some aspects, the component processor 210 stores the printer condition information in cache 238.

The component processor 210 gathers print subsystem-external information related to the print job by gathering information from a node such as a print subsystem host 250, the printer 236, the printer device manager 234, or a print service (not shown).

One advantage of the present invention backplane is that a document can be efficiently processed in the independent IR document format, without dependence upon a particular language and/or printer model. For example, the controller 204 may accept a print job in a first language format associated with a first printer device type. Meanwhile, the component processor 210 may use print subsystem-external information related to the print job to select a second printer device type. This printer-selection process is an example an indirect document process, mentioned above. The component processor 210 then converts the IR document into a processed print job in a second language format associated with the second printer device type.

The component processor 210 may call a plurality of plugins and use the plurality of plugins to perform an action such as parallel processing the IR document. Alternately, the plugins may be used to serial process the IR document, or process the IR document using a combination of parallel and serial processes.

The use of multiple plugins can result in the creation of multiple processed IR documents. As a result, it is possible that conflicts may exist between processed IR documents. To take a simple example, a first processed IR document may define a 12-point font, while a second processed IR document defines a 10-point font. If so, the component processor 210 reassembles IR documents to remove conflicts between a plurality of processed IR documents and converts the plurality of IR documents into the (single) processed print job.

In other aspects, the backplane 201 includes a shared data memory 240. The component processor 210 accepts the IR document on line 208 and stores the IR document in the shared data memory 240. Then, the component processor 210 accesses the IR document from shared data memory 240 for processing. The component processor is able to resolve conflicts between variations in the processed IR documents as a result of each plugin accessing the original IR document from memory 240. In a chain of print filters (prior art), the output of a first filter is the input to a second filter. It is possible that the second filter may undo the result of the first filter, or create an undesirable result as a result of operating on previously modified data. In the present invention each processed IR document includes annotations, to differentiate original data from modified data. In the event of a conflict between processed IR documents, the component processor 210 is able to compare the annotations in the conflicting documents to the original. As a last resort, the component processor 210 is able to return conflicted data to the initial condition. Additionally, the component processor 210 may resolve conflicts by calling other plugins.

### Functional Description

The present invention differs from the prior art solutions mentioned in the Background Section in that it can support an unlimited number of custom actions, where no action needs to be aware of any other action. The custom actions are implemented as plugins. The plugins are associated with predefined components within the backplane that are independent of order. The backplane is composed of multiple components, where each component handles a different operational concept, such as job analysis/modification, job accounting, job control, job monitoring/recovery, job despooling, device monitoring, and security.

The despooling backplane is dynamically configurable. Custom actions can be added/removed as configurable plugins. These plugins can be preconfigured or configured at run-time. The support of new job control languages and page description languages (PDLs), as well as other print data representations (e.g., raster), can be dynamically added as PJL/PDL parser plugins. There is no redundancy in repeating common operations. For example, a print job is parsed only once. Jobs are converted into an intermediate representation that is language independent, and in a common format for all print data operations. Other common imaging tasks, such as device monitoring, are handled by the backplane components and stored as common data. A common external interface is supported for access to common shared data used in bi-directional communication with other print subsystem components, such as the print monitor for example.

### Despooling Backplane-Default System Behavior Bypass

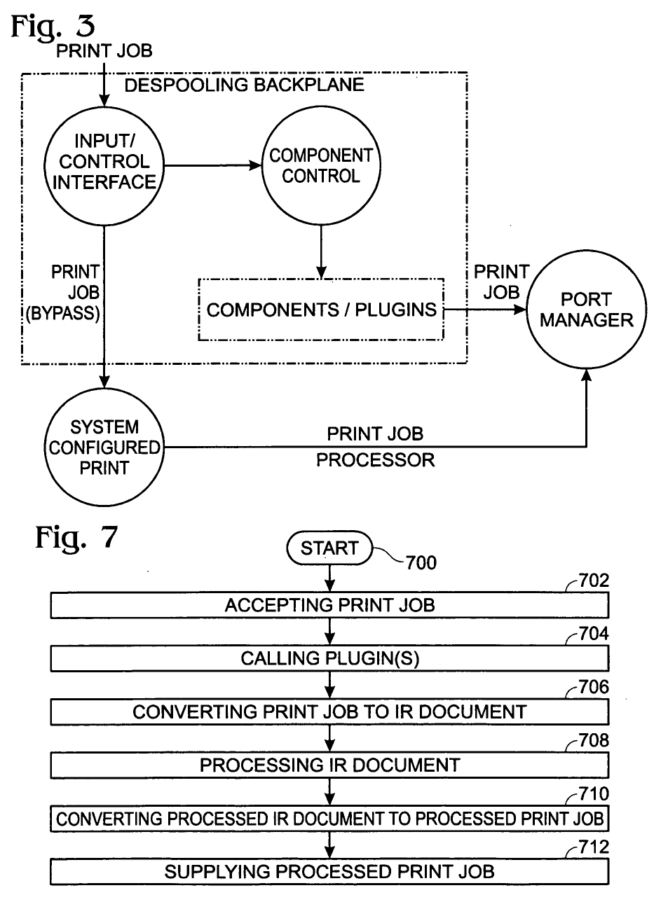

FIG. 3 is a diagram depicting a default system bypass. The despooling backplane may be integrated into the despooling side of a print subsystem through conventional methods. These methods include, but are not limited to an enhanced print spooler, a custom print processor, a custom port manager, or a print assist

In each of the above conventional cases, the input, output, and control interfaces of the despooling backplane conform to the mating print subsystem interfaces. In one aspect, the present invention despooling backplane is a custom print processor. The despooling backplane (print processor) appears to perform actions in addition to, or replacement of the system (default) print processor.

In one aspect of the invention, the despooling backplane implements a bypass at the input, output and control interfaces, to bypass the behavior of the despooling backplane. In this manner, the system (default) print processor behaviors are performed. The despooling backplane may itself bypass into another system configured custom component, such as a custom print processor.

This bypass can be dynamically configured to be enabled or disabled without reinstallation or reinvocation. For example, the bypass can be used to implement despooling backplane access control. One example of a custom print processor bypass is disclosed in a pending application entitled, PRINTER DRIVER CUSTOMIZATION USING INCREMENTAL CUSTOM PRINT PROCESSOR, invented by Andrew Ferlitsch, Ser. No. 10/269,378, filed on Oct. 10, 2002, which is incorporated herein by reference.

Despooling Backplane General Layout

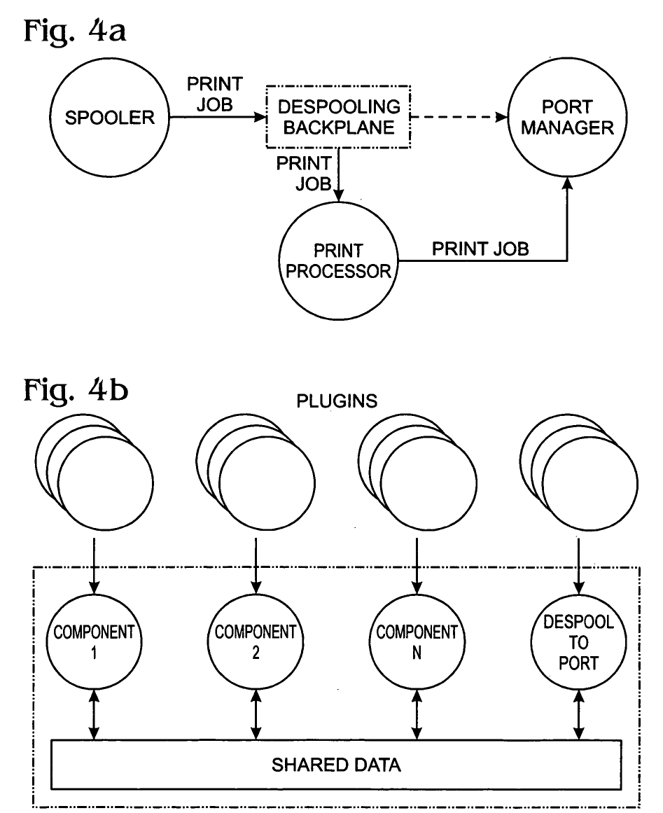

FIGS. 4a and 4b are alternate depictions of the despooling backplane of FIG. 2. The despooling backplane is implemented in configurable and intercommunicating components. Each component performs a distinct despooling action related to the imaging job. These actions include, but are not limited to:

1. Print Job Analysis

2. Print Job Modification

3. Journaled Data Playback

4. Job/Device Scheduling

5. Job/Device Monitoring

6. Job/Device Control

7. Job Routing

8. Output Control

9. Job/Device Error Handling and Recovery

10. Accounting and Access Control

11. Security

12. Distributed Services

Regardless of the number of components and associated actions in the despooling backplane, the despooling backplane may be considered to include two components, a component that implements the input and control interface, and a component that implements the output interface. In the case of a custom print processor, the input and control interface is the interface between the print spooler and the print processor. The output interface is the interface between the print processor and the port manager.

Each component interfaces with the despooling backplane through shared data, where the shared data is a common format (intermediate representation) interpretable by each component. None of the components directly interface with, or otherwise need to have knowledge of the other components. Control of the components is implemented through a centralized component control process that interfaces with the input and control component.

The behavior of each component can be customized by configuring one or more plugins. Examples of customization include, but are not limited to, adding a behavior in addition to, modifying a behavior, deleting a behavior, or replacing a behavior.

Each plugin may implement an external customization. For example, one component may implement a device availability function. The component performs some default behavior, such as querying the print spooler for the device's status. The function can be enhanced to query the device by using a plugin to implement an SNMP device query, to determine device status. Additionally, some devices may have proprietary SNMP fields that provide additional status information that would not be available from the standard SNMP MIB protocol. These device-specific queries might be implemented as additional plugins.

Example Component: Print Job Parser

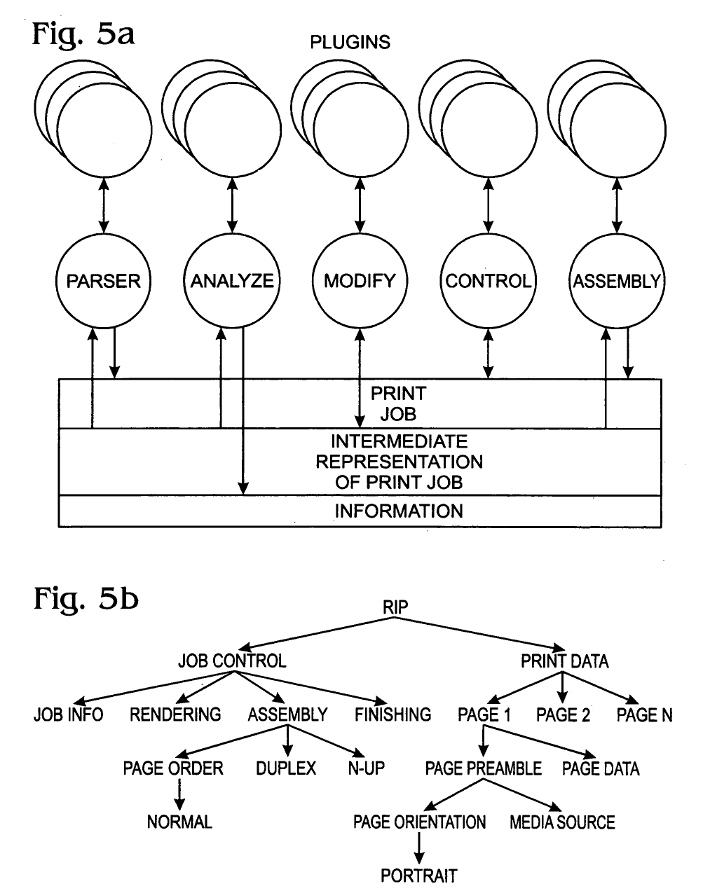

FIGS. 5a and 5b are depictions of present invention exemplary print job parsing functions. In this aspect one component of the despooling backplane implements a print job parsing function, referred to herein as IR document translation. This print job parser component performs functions that include, but are not limited to:

1. Parsing spool/RIP header and footers.

2. Parsing print job control header.

3. Parsing PDL data.

4. Converting the parsed data into an intermediate representation.

5. Storing the intermediate representation into the shared data.

Additional components may implement post-parsing (IR translation) functions, such as, but not limited to:

1. Analyzing the intermediate representation. For example, determining the number of physical sheets required to print the job.

2. Storing the analyzed information in a common format/convention into the shared data.

3. Gathering external information, such as the host name and network address, and identification of the print generation process (e.g., printer driver), that might be useful in the parsing, analysis, modification, or any other operation associated with the intermediate representation of the print job.

4. Storing the external information in a common format/convention into the shared data.

5. Changing the print job by modifying the intermediate representation of the print job.

6. Saving the modified intermediate representation of the print job into the shared data.

7. Reassembling the (un)modified print job from the intermediate representation back into a print job. The reassembled print job may be in the original print job format (e.g., PJL/PCL) or converted to another format (e.g., PJL/PS).

In the above-described method, the component controller and components may perform operations that include, but are not limited to:

1. The component controller loading the location of the spool data for the print job into the shared data.

2. The component controller calling the print job parsing component (IR document translating function).

3. The print job parsing component loading plugins for parsing the spool header.

4. The print job parsing component invoking each spool header parsing plugin until one plugin acknowledges format recognition. The spool header parsing plugin parsing the spool file header and writing the intermediate representation of the spool file header to the shared data (auto-spool header format recognition); or invoking a predetermined sequence of spool header parsing plugin(s) based on explicit knowledge of the spooler header format such as knowing the printer driver that generated the spool data (explicit-spool header format recognition); or calling a default sequence of spool header parsing plugin(s) when the spool header format cannot otherwise be determined (default-spool header format recognition).

5. The print job parsing component loading plugins for parsing the print job control header (e.g., PJL).

6. The print job parsing component invoking each print job control header parsing plugin until one plugin acknowledges recognition of the format (auto-print job header format recognition); or invoking a predetermined sequence of print job header parsing plugin(s) based on explicit knowledge of the print job header format (explicit-print job header format recognition); or calling a default sequence of print job header parsing plugin(s) when the print job header format cannot otherwise be determined (default-print job header format recognition).

7. The print job control header parsing plugin parsing the print job control header and writing the intermediate representation of the print job control header to the shared data.

8. The print job parsing component loading plugins for parsing the print data (e.g., PDL).

9. The print job parsing component invoking each print data parsing plugin until one plugin acknowledges recognition of the format, such as PCL (auto-print data format recognition); or invoking a predetermined sequence of print data parsing plugin(s) based on explicit knowledge of the print data format (explicit-print data format recognition); or calling a default sequence of print data parsing plugin(s) when the print data format cannot otherwise be determined (default-print data format recognition).

10. The print data parsing plugin parsing the print data and writing the intermediate representation of the print data to the shared data.

11. The component controller calling the print job analysis component.

12. The print job analysis component loading the print job analysis plugins.

13. Each print job analysis plugin reading the intermediate representation of the print job and performing its respective analysis.

14. Each print job analysis plugin writing the analyzed information into the shared data using a command format/convention.

15. The component controller calling the print job modification component.

16. The print job modification component loading the print job modification plugins.

17. Each print job modification plugin updating the intermediate representation of the print job in shared data, according to its respective function.

18. The component controller calling the print job assembly component.

19. The print job assembly component determining the output format for the print job.

20. The print job assembly component loading the plugin(s) associated with the output format(s).

21. The component controller calling the print job control component.

22. The print job control component loading the job control plugins.

23. Each print job control component updating intermediate representation of the print job in shared data and control of the print job, according to its respective function.

24. The loaded plugin(s) reconstructing the print job into the output format from the intermediate representation.

25. The print job assembly component storing the location of reassembled print job in the shared data.

Example Component: Device Availability

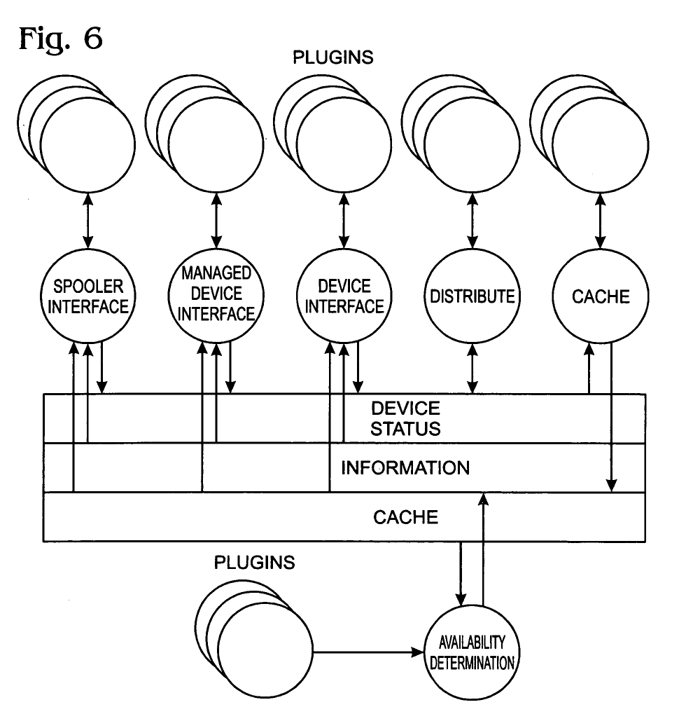

FIG. 6 is a diagram illustrating a device availability aspect of the present invention. One component of the despooling backplane may implement the device availability function. This component may perform functions including, but not limited to:

1. Determining the availability of a device from the print spooler.

2. Determining the availability of a device from a device manager, if any, such as a print server.

3. Determining the availability of a device from the device.

4. Determining the availability of a device from other distributed services.

5. Generating a composite determination of the availability of a device from the available sources.

6. Maintaining a cache of device availability information/status.

Additional components may implement post-despooling functions, such as, but not limited to:

1. Monitoring the status of a device during printing of a print job.

2. Monitoring job completion status from the device.

3. Determining the next-most available device for restarting a failed print job.

In the above-described method, the component controller and the above components may perform operations including, but not limited to:

1. The component controller calling the device availability component.

2. The device availability component loading plugins associated with obtaining the status from the print spooler of an installed printer associated with the device.

3. The device status from print spooler plugin querying the cache for previously stored status information on the device from the print spooler.

4. If the status is in not in the cache, or is stale, the plugin obtaining the device status from the print spooler and updating the cache.

5. The plugin storing the device status obtained from the print spooler into the shared data in a common format/convention.

6. The device availability component loading plugins associated with obtaining status from a device manager, such as a print server.

7. The device manager plugin (optionally) loading additional plugins for specific types of device managers, such as a Microsoft Windows NT® print server or a Netware Novel® print server.

8. The device manager plugin querying the cache for previously stored status information on the device from the device manager.

9. If the status is in not in the cache, or is stale, the plugin obtaining the device status from the device manager and updating the cache.

10. The plugin storing the device status obtained from the device manager into the shared data in a common format/convention.

11. The device availability component loading plugins associated with obtaining status from a device, such as by a peer-peer network protocol.

12. The device plugin optionally loading additional plugins for specific peer-peer network protocols, such as Simple Network Management Protocol (SNMP) and PJL USTATUS, and proprietary device protocols (e.g., Sharp NJR) and protocol extensions, such as extended management information bases (MIBs).

13. The device plugin querying the cache for previously stored status information on the device (printer), from the device.

14. If the status is in not in the cache, or is stale, the plugin obtaining the device status from the device and updating the cache.

15. The plugin storing the device status obtained from the device into the shared data in a common format/convention.

16. The device availability component loading plugins for determining the availability of the device based on the collected information.

17. The availability determination plugin reading information from the shared data, such as device attributes (e.g., ppm) and device status (e.g., ready, busy, error), and determining the availability of the device.

18. The availability determination plugin storing the availability of the device in the shared data in a common format/convention.

FIG. 7 is a flowchart illustrating the present invention method for managing print jobs using a print subsystem despooling backplane. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 700.

Step 702 accepts a print job at a print subsystem despooling backplane input interface. Step 704 calls a despooling backplane plugin. Step 706 converts the print job into an internal representation (IR) document. Typically, Step 706 converts the print job into an IR document that is independent of a printer device target and the language format associated with a printer device target. Step 708 processes the IR document in response to a plugin. Step 710 converts the processed IR document into a processed print job. Step 712 supplies the processed print job at a despooling backplane output interface.

In some aspects of the method, calling a despooling backplane plugin in Step 704 includes calling plugins such as: user-selected plugins; predetermined plugins responsive to criterion such as printer driver, printer model, printer configuration, printer condition, user, administrative grouping, document content, and/or document type; and/or plugins called from other (previously called or concurrently running) plugins.

In other aspects, processing the IR document (Step 708) includes performing a process such as translating the print job into an IR document, analyzing, modifying the print job data, modifying control of the print job, gathering print subsystem-external information related to the print job, producing print subsystem-external information related to the print job, setting print subsystem-external information related to the print job, and/or reassembling IR documents.

Gathering print subsystem-external information related to the print job (Step 708) may include monitoring a printer condition such as the availability of connected printing devices, currently printing print jobs, pending print jobs, completed print jobs, print job failures, printer performance, printer locality, consumables, and/or printer capabilities. Further, monitoring a printer condition may include the substeps (not shown) of: querying a node such as a print subsystem spooler, a print subsystem port manager, a printer manager, print service, and/or a printer; and, maintaining a cache of printer condition information. Step 708 may include gathering print subsystem external information from a node such as a print subsystem host, a printer, a printer device manager, or a print service.

In other aspects, translating the print job into an IR document (Step 708) includes parsing spool/raster image processor (RIP) footers and headers, parsing a print job control header, and parsing language data, such as raster, image, or page description language (PDL) data. Parsing a print job control header includes: calling a plurality of printer job control header plugins such as printer job language (PJL) and job definition format (JDF) plugins; and, using the print job control header plugin that recognizes the print job control header data.

Likewise, parsing language data may include: calling a plurality of language plugins such as raster, image, printer control language (PCL), portable document format (PDF), PostScript (PS), PCL XL, HP GL/2, IPDS, Escape P, SCS, and TIFF plugins; and, using the language plugin that recognizes the language data.

Analyzing the IR document (Step 708) may include performing an action such as job accounting, job control, printer pooling, job splitting, access control, security, content filtering, resource downloading, compression, reformatting, and/or language translation.

In some aspects, calling a despooling backplane plugin (Step 704) includes calling a plurality of plugins. Then, processing the IR document in Step 708 includes using the plurality of plugins to perform an action such as parallel processing the IR document, serially processing the IR document, or processing the IR document using a combination of parallel and serial processes.

In other aspects, reassembling IR documents (Step 708) includes removing conflicts between a plurality of processed IR documents. Then, converting the processed IR document into a processed print job (Step 710) includes converting the plurality of IR documents into the processed print job.

In one aspect, accepting a print job at a print subsystem despooling backplane input interface (Step 702) includes accepting a print job in a first language format associated with a first printer device type, and setting print subsystem-external information related to the print job (Step 708) includes selecting a second printer device type. Then, converting the processed IR document into a processed print job (Step 710) includes converting the IR document into a processed print job in a second language format associated with the second printer device type.

In another aspect, converting the print job into an IR document (Step 706) includes storing the IR document as shared data. Then, processing the IR document in Step 708 includes processing the IR document accessed from shared data.

A despooling backplane and a method for managing print jobs using the despooling backplane have been provided. Examples of processes (plugins) have been used to illustrate the invention. However, the invention is not limited to just the listed processes. Although the processes have been explained as operations associated with a printer, the invention has equal relevance to scanners, fax machines, document servers, and other imaging equipment. Further, although an example of a despooling backplane has been given, enabled as a print processor, the despooling backplane can also be enabled with other elements of a print subsystem, such as in the spooler, port manager, or print assist.

Although the invention has generally been explained in the context of a Microsoft Windows® operating system, the invention can also be practiced with subsystems of an Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS and AS/400 Operating System, to name a limited list of other possibilities. Other variations and embodiments of the invention will occur to those skilled in the art.

1. A method for managing print jobs using a print subsystem despooling backplane, the method comprising:
accepting a print job at a print subsystem despooling backplane input interface;
calling a despooling backplane plugin;
converting the print job into an internal representation (IR) document;
processing the IR document in response to a plugin;
converting the processed IR document into a processed print job; and, supplying the processed print job at a despooling backplane output interface.

2. The method of claim 1 wherein calling a despooling backplane plugin includes calling plugins chosen from the group including:
user-selected plugins;
predetermined plugins responsive to criterion such as printer driver, printer model, printer configuration, printer condition, user, administrative grouping, document content, and document type; and,
plugins called from other plugins.

3. The method of claim 1 wherein converting the print job into an IR document includes converting the print job into an IR document that is independent of a printer device target and the language format associated with a printer device target.

4. The method of claim 3 wherein processing the IR document in response to the plugin includes performing a process selected from the group including translating the print job into an IR document, analyzing, modifying the print job data, modifying control of the print job, gathering print subsystem-external information related to the print job, producing print subsystem-external information related to the print job, setting print subsystem-external information related to the print job, and reassembling IR documents.

5. The method of claim 4 wherein calling a despooling backplane plugin includes calling a plurality of plugins; and,
wherein processing the IR document in response to the plugin includes using the plurality of plugins to perform an action selected from the group including parallel processing the IR document, serially processing the IR document, and processing the IR document using a combination of parallel and serial processes.

6. The method of claim 5 wherein reassembling IR documents includes removing conflicts between a plurality of processed IR documents; and,
wherein converting the processed IR document into a processed print job includes converting the plurality of IR documents into the processed print job.

7. The method of claim 4 wherein accepting a print job at a print subsystem despooling backplane input interface includes accepting a print job in a first language format associated with a first printer device type;
wherein setting print subsystem-external information related to the print job includes selecting a second printer device type; and,
wherein converting the processed IR document into a processed print job includes converting the IR document into a processed print job in a second language format associated with the second printer device type.

8. The method of claim 4 wherein gathering print subsystem-external information related to the print job includes monitoring a printer condition selected from the group including the availability of connected printing devices, currently printing print jobs, pending print jobs, completed print jobs, print job failures, printer performance, printer locality, and printer capabilities.

9. The method of claim 8 wherein monitoring a printer condition includes:
querying a node selected from the group including a print subsystem spooler, a print subsystem port manager, a printer manager, a print service, and a printer; and,
maintaining a cache of printer condition information.

10. The method of claim 1 wherein converting the print job into an IR document includes storing the IR document as shared data; and,
wherein processing the IR document in response to the plugin includes processing the IR document accessed from shared data.

11. The method of claim 4 wherein translating the IR document includes parsing spool/raster image processor (RIP) footers and headers, parsing a print job control header, and parsing language data selected from the group including raster, image, and page description language (PDL) data.

12. The method of claim 11 wherein parsing a print job control header includes:
calling a plurality of printer job control header plugins selected from the group including printer job language (PJL) and job definition format (JDF) plugins; and,
using the print job control header plugin that recognizes the print job control header data.

13. The method of claim 11 wherein parsing language data includes:
calling a plurality of language plugins selected from the group including raster, image, printer control language (PCL), portable document format (PDF), PostScript (PS), PCL XL, HP GL/2, IPDS, Escape P, SCS, and TIFF plugins; and,
using the language plugin that recognizes the language data.

14. The method of claim 4 wherein analyzing the IR document includes performing an action selected from the group including job accounting, printer pooling, job splitting, access control, security, content filtering, resource downloading, compression, reformatting, and language translation.

15. The method of claim 4 wherein gathering print subsystem-external information related to the print job includes gathering information selected from the group including a print subsystem host, a printer, a printer device manager, and a print service.

16. A print subsystem despooling backplane, the backplane comprising:
a library of despooling backplane plugins;
a controller having an interface to accept a print job, the controller converting the print job to an internal representation (IR) document and supplying the IR document at an interface;
a component processor having an interface to call a plugin from the library and an interface to accept the IR document, the component processor processing the IR document in response to a plugin, converting the processed IR document into a processed print job, and supplying the processed print job at an interface.

17. The backplane of claim 16 wherein the component processor calls plugins chosen from the group including:
user-selected plugins;
predetermined plugins responsive to criterion such as printer driver, printer model, printer configuration, printer condition, user, administrative grouping, document content, and document type; and,
plugins that are called from other plugins.

18. The backplane of claim 16 wherein controller converts the print job into an IR document that is independent of a printer device target and the language format associated with a printer device target.

19. The backplane of claim 18 wherein the component processor performs a process selected from the group including translating the print job into an IR document, analyzing, modifying the print job data, modifying control of the print job, gathering print subsystem-external information related to the print job, producing print subsystem-external information related to the print job, setting print subsystem-external information related to the print job, and reassembling IR documents.

20. The backplane of claim 19 wherein the component processor calls a plurality of plugins and uses the plurality of plugins to perform an action selected from the group including parallel processing the IR document, serially processing the IR document, and processing the IR document using a combination of parallel and serial processes.

21. The backplane of claim 20 wherein the component processor reassembles IR documents to remove conflicts between a plurality of processed IR documents and converts the plurality of IR documents into the processed print job.

22. The backplane of claim 19 wherein the controller accepts a print job in a first language format associated with a first printer device type; and,
wherein component processor uses print subsystem-external information related to the print job to select a second printer device type and convert the IR document into a processed print job in a second language format associated with the second printer device type.

23. The backplane of claim 19 wherein the component processor gathers print subsystem-external information related to the print job by monitoring a printer condition selected from the group including the availability of connected printing devices, currently printing print jobs, pending print jobs, completed print jobs, print job failures, printer performance, consumables, printer locality, and printer capabilities.

24. The backplane of claim 23 wherein the component processor monitors a printer condition includes by:
querying a node selected from the group including a print subsystem spooler, a print subsystem port manager, a printer manager, a print service, and a printer; and,
storing the printer condition information in cache.

25. The backplane of claim 16 further comprising:
a shared data memory; and,
wherein the component processor accepts the IR document, stores the IR document in the shared data memory, and accesses the IR document from shared data memory for processing.

26. The backplane of claim 19 wherein the component processor translates the print job into an IR document by parsing spool/raster image processor (RIP) footers and headers, parsing a print job control header, and parsing language data selected from the group including raster, image, and page description language (PDL) data.

27. The backplane of claim 26 wherein the component processor parses a print job control header by:
calling a plurality of printer job control header plugins selected from the group including printer job language (PJL), and job definition format (JDF); and,
using the print job control header plugin that recognizes the print job control header data.

28. The backplane of claim 26 wherein the component processor parses the language data by:
calling a plurality of language plugins selected from the group including raster, image, printer control language (PCL), portable document format (PDF), PostScript (PS), and PCL XL, HP GL/2, IPDS, Escape P, SCS, and TIFF plugins; and,
using the language plugin that recognizes the language data.

29. The backplane of claim 19 wherein component processor analyzes the IR document by performing an action selected from the group including job accounting, job control, printer pooling, job splitting, access control, security, content filtering, resource downloading, compression, reformatting, and language translation.

30. The backplane of claim 19 wherein the component processor gathers print subsystem-external information related to the print job by gathering information selected from the group including a print subsystem host, a printer, print service, and a printer device manager.
